(19) United States
(12) Patent Application Publication
(10) Pub. No.: US 2023/0385163 A1
(43) Pub. Date: Nov. 30, 2023

(54) BACKUP AND RESTORE OF GENERAL DATA FOR FIELD DEVICES BY MEANS OF ADD-ON MODULE

(71) Applicant: VEGA GRIESHABER KG, Wolfach (DE)

(72) Inventors: Ralf HOELL, Titisee-Neustadt (DE); Juan GARCIA, Biberach (DE)

(73) Assignee: VEGA GRIESHABER KG, Wolfach (DE)

(21) Appl. No.: 18/323,008

(22) Filed: May 24, 2023

(30) Foreign Application Priority Data
May 24, 2022 (EP) 22175209.0

(51) Int. Cl. G06F 11/14

(52) U.S. Cl. CPC G06F 11/1469; G06F 11/1464; G06F 2201/84

(57) ABSTRACT

A data backup add-on module for a field device, the add-on module including a coupling device that couples the add-on module to the field device, a data interface device that provides a first data communication link between the field device and the add-on module and provides a second data communication link between the add-on module and a cloud-based system and a backup device that stores the backup data for data backup for a field device on the cloud-based system using the first data communication link and the second data communication link.

### CROSS-REFERENCE TO RELATED APPLICATIONS

This application claims the benefit of the filing date of European Patent Application No. 22 175 209.0 filed on 24 May 2022, the entire content of which is incorporated herein by reference.

### FIELD OF PRESENT DISCLOSURE

The present disclosure relates to an add-on module for a backup and restore (restore) to a cloud by way of an operating and display module. In particular, the present disclosure relates to an add-on module for data backup for a field device as well as a corresponding method and a corresponding field device.

### BACKGROUND

Today's field devices from the area of process and/or factory automation, such as sensors for level, limit level, pressure, flow, temperature, analysis can be connected to higher-level systems by wire or wirelessly and communicate with these systems.

Wired field devices are typically connections to 4 . . . 20 mA/HART, Profibus, Foundation Fieldbus (FF), or two-wire Ethernet, also named APL technology. Profibus PA and Foundation Fieldbus (FF) is a fully digital, serial, bidirectional communication system that serves as a field device bus system in a plant or process automation environment. Profibus PA and FF are based on IEC 61158-2 and are fieldbus systems for process automation, i.e. 2-wire, with a range of around 1000 m and intrinsically safe in the sense of Ex i, Intrinsic Safety (Ex i). Intrinsic safety is a technical property of a device or system which, due to special design principles, ensures that no unsafe condition occurs even in the event of a fault.

Wireless field devices are typically WirelessHart, LoRa, NB-IoT, Sigfox or other wireless communication protocols transmitted via Bluetooth or WLAN.

The higher-level systems are, for example, programmable logic controllers (PLCs), gateways such as LoRa (Long Range), or server-based systems such as SCADA systems.

With such field devices, backups and restores, also referred to as “backups” or “restores” in the following, typically have to be performed by connected operating devices, such as a PC, laptop, smartphone or tablet. This is often cumbersome, connecting devices on site is time-consuming (taking operating devices with you, maintenance of the operating devices, cable connections if necessary, obtaining a fire permit if necessary in the case of explosion-hazardous systems . . . ) and usually involves preparatory and follow-up work (backup from local laptop to server).

### SUMMARY

The present disclosure discloses means for securing and restoring, or backup and restore, general data such as device parameters, diagnostic data or software update for field devices in the field of process or factory automation by a module with radio communication.

In accordance with a first aspect of the present disclosure, there is provided a data backup add-on module for a field device, the add-on module comprising a coupling device adapted to couple the add-on module to the field device.

Further, the add-on module comprises a data interface device configured to provide a first data communication link, typically configured as a contact/cable link, between the field device and the add-on module, and to provide a second data communication link, typically configured as a wireless communication interface, between the add-on module and a web server.

Further, the add-on module comprises a backup device configured to store the backup data for data backup for a field device on the web server (typically as a central data storage) using the first data transmission connection and the second data transmission connection.

Advantageous embodiments are the subject of the dependent claims and the following description.

With the listed state of the art, the requirements, and thus also the possibilities, for today's field devices are becoming ever greater. For example, the field devices have more parameterization and, above all, more extensive diagnostic options, but also the increasing digitization requires an increase in safety again and again, so that software updates (functional or safety-related) may be required in shorter cycles.

For an operator of a plant, this means that the effort for maintenance and care of the field devices, as described above in the use cases, but also of his operator interfaces increases.

The advantageous solution of the present disclosure is, for example, in an exemplary embodiment, a pluggable or connectable module or add-on module with integrated radio technology, with which a backup and restore function of field devices can very easily be carried out automatically, by way of a cloud-based system (e.g. web server). Another advantage is the central data storage in the cloud-based system.

Typically, these are wired field devices with 4 . . . 20 mA/HART, Profibus, Foundation Fieldbus (FF) or two-wire Ethernet (APL technology) interface. As a rule, it is about sensors for level, limit level, pressure, flow, temperature, analysis or other measured variables, for example.

For example, in an exemplary embodiment, the advantageous solution of the present disclosure is a pluggable or connectable module or add-on module with radio technology:

According to an embodiment of the present disclosure, the add-on module with radio technology can be plugged or connected to the field device during operation of the field device. The plugging or connecting establishes the communication from the add-on module (additional module) to the field device. According to one embodiment of the present disclosure, for example, this can be done via a plug connection, sliding contacts, optically or other contact or contactless technologies. According to one embodiment of the present disclosure, the add-on module receives its energy from the field device or can also be provided or supplemented by an integrated battery.

According to an embodiment of the present disclosure, the add-on module may thereby include a display or other optical signaling, such as LEDs or light rings, as an optical interface to the operator. The add-on module has included at least one radio technology, such as cellular (LTE, NB-IoT), low power wide area network (LoRa), Sigfox, wireless local area networks (WLAN), or other radio technologies suitable therefor, which performs the communication between the add-on module and the cloud-based, higher-level system.

According to an embodiment of the present disclosure, the add-on module can be designed as a plug-in indicating and adjustment module, such as a PLICSCOM, and can also be designed to display measured values.

According to an embodiment of the present disclosure, the add-on module can contain a further radio technology, such as for short-range radio, for example Bluetooth, which can be used for an optional operating device, for example a parameterization and diagnosis. Furthermore, according to one embodiment of the present disclosure, the add-on module has a selector switch for different operating modes, such as backup and restore, which can be implemented both mechanically or also internally as a function module.

After the operator has plugged in the add-on module, the data is automatically transferred between the field device and the cloud-based system in both backup and restore modes.

In the Backup operating mode, all backup data is read from the field device by the add-on module and transferred to the cloud-based system. In the Restore operating mode, all previously set restore data for this device type, e.g., last parameterization data or software update, are transferred from the cloud-based system to the add-on module and written from there to the field device. The multitude of these process steps are processed automatically without the operator's intervention.

The operator is informed by the optical display on the add-on module when the transfer is completed and which function direction (backup or restore) is set. Optionally, he can also be informed on his operating device (e.g. smartphone with operating APP), as this can be connected to the add-on module via short-range radio (e.g. Bluetooth).

According to an embodiment of the present disclosure, it is provided that the coupling device comprises a connector which is designed to be detachably fixed to the field device by positive locking, by spring force or by screwing.

According to an embodiment of the present disclosure, it is provided that the add-on module further comprises a power supply device which is designed to provide a power supply to the add-on module via the field device, preferably via a wired field device with 4 . . . 20 mA HART standard, and/or via an electrical energy storage integrated in the add-on module.

According to an embodiment of the present disclosure, it is provided that the add-on module further comprises a display device configured to output a visual data display or signaling to an operator.

According to an embodiment of the present disclosure, the data interface device is adapted to provide the first data communication link (first data transmission link) and/or the second data communication link (second data transmission link) via first, second or third generation cellular standard, narrowband Internet of Things, low energy wide area network or wireless local area network.

According to an embodiment of the present disclosure, the data interface device is designed to provide a third data communication link between the add-on module and an operating device via short-range radio technology. Preferably, this is also designed to be wireless (e.g. via Bluetooth).

According to an embodiment of the present disclosure, the backup device is designed to store the backup data for data backup for the field device in a backup mode as individual parameters, as parameter blocks for linearization or for interference signal suppressions, as measured value memories, as event memories, as drag pointers, as configuration data, as field device information, as diagnostic data, or as certificates.

According to an embodiment of the present disclosure, the backup device is designed to copy the backup data back to the field device in a restore mode as individual parameters, as parameter blocks for linearization or for interference signal suppressions, as measured value memories, as event memories, as drag pointers, as configuration data, as field device information, as diagnostic data, or as certificates.

According to an embodiment of the present disclosure, the add-on module further comprises an input device configured to switch the add-on module between restore mode and backup mode.

According to an embodiment of the present disclosure, the coupling device is adapted to identify the field device and provide a unique sensor identifier, preferably a serial number, a device type, a manufacturer, or a marker tag, for the field device, wherein the add-on module is adapted to provide the backup data with the unique sensor identifier.

According to an embodiment of the present disclosure, it is provided that the add-on module is adapted to provide the backup data with a time stamp.

According to an embodiment of the present disclosure, it is provided that the add-on module further comprises a data memory which is designed to store additional recovery data, preferably software data in the form of a software update by means of an add-on module for field devices or certificates.

According to an embodiment of the present disclosure, it is provided that the add-on module further comprises cloud interface means adapted to provide a connection to cloud-based systems, preferably for authenticating the add-on module or for using the add-on module via a user interface device or for providing two-factor authentication.

According to an aspect of the present disclosure, a method is provided, the method comprising the following method steps:

As a first step, the add-on module is coupled with the field device.

As a second step, providing a first data communication link or data transfer connection between the field device and the add-on module and providing a second data communication link between the add-on module and a cloud-based system.

As a third step, storing backup data for data protection for the field device is performed on the cloud-based system using the first data communication link and the second data transfer connection.

According to an embodiment of the present disclosure, it is provided that the method is carried out using a field device such as a level meter.

The present disclosure allows the add-on module to be easily plugged or connected by the operator on site, during operation, without any additional means.

The present disclosure allows that the operator does not need any special qualification or advanced knowledge for using the backup or restore function

The present disclosure enables operating devices, such as a laptop, smartphone or tablet, to be unnecessary for backup or restore, which also do not need to be maintained, carried on site or prepared. For the hazardous area, additional measures such as obtaining a fire permit are not required. Manual rework, such as storing the backup data, is not required.

The add-on module with radio can be used for all field devices that support this interface to the add-on module. There is a central storage of such data Thus, the data are not scattered on different operating devices. The use of modern infrastructures is guaranteed, thus future-proof.

The present disclosure enables all backup data to always be automatically backed up in the cloud-based system, centrally. The digital image of the respective field devices is immediately available in the cloud-based system. Multiple backups of a field device can be performed if required. If required, several backups of several field devices can be performed in succession without a memory becoming full.

During a restore, the sensor is automatically set to “maintenance mode” so that the health status of the field device can also be recognized in the higher-level system in the form of a diagnostic message.

The previously desired and set restore data is always saved automatically in the field device. Several restores can be performed on several field devices in succession, e.g. software update. By simply plugging in, the download of the correct backup data by unique identification takes place.

Potential vulnerabilities of the field devices can be clearly displayed in the cloud, such as certain field devices that have not yet received the latest security updates. Connection to other cloud-based systems, such as the software database of manufacturer x or y including automatic synchronization, can be ensured. A general overview of all field devices in the plant and thus the plant status is created.

The present disclosure, from the field of process or factory automation, describes a simple, safe and automatic possibility of a backup and restore of general data in field devices by means of an add-on module with radio. The add-on module can be plugged or connected to the field device without any special knowledge of the user.

Further embodiments of the present disclosure are described below with reference to the figures. If the same reference signs are used in the following description of figures, these designate the same or similar elements. The illustrations in the figures are schematic and not to scale.

### BRIEF DESCRIPTION OF THE FIGURES

FIG. 1 shows an add-on module with a plurality of interfaces according to an embodiment of the present disclosure.

FIG. 2 shows an automatic backup with add-on module stored in the cloud according to an embodiment of the present disclosure.

FIG. 3 shows a backup with add-on module automatically stored in the cloud according to an embodiment of the present disclosure.

FIG. 4 shows a restore with add-on module automatically retrieved from the cloud according to an embodiment of the present disclosure.

FIG. 5 shows a restore with add-on module automatically retrieved from the cloud in addition with at least one further cloud according to an embodiment of the present disclosure.

FIG. 6 shows a restore with add-on module via smartphone with Bluetooth as selection, with data exchange automatically from the cloud according to another embodiment of the present disclosure.

FIG. 7 shows a restore with add-on module via smartphone mobile radio as a selection, with data exchange automatically from the cloud according to another embodiment of the present disclosure.

FIG. 8 shows an add-on module according to a further embodiment of the present disclosure.

### DETAILED DESCRIPTION OF EMBODIMENTS

The following is a description of embodiments according to embodiments of the present disclosure.

The representations in the figures are schematic and not to scale.

If the same reference signs are used in different figures in the following figure description, these designate the same or similar elements. However, identical or similar elements can also be designated by different reference signs.

According to another embodiment of the present disclosure, an add-on module is implemented with all interfaces.

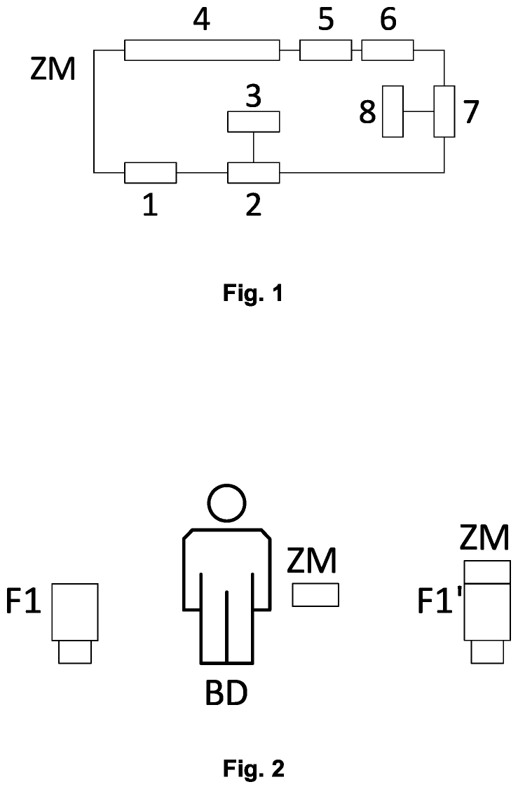

FIG. 1 schematically shows the add-on module according to one embodiment of the present disclosure, which can be plugged or connected to a field device F.

According to an embodiment of the present disclosure, the add-on module includes the following elements: an interface 1 to a field device, a power supply 2 from field device, an optional battery/battery 3, an optional signaling 4, a second radio link 5 to a first cloud, a third radio link 6 to an optional operator interface, a selector switch 7 for selecting an operating mode, a function block 8 for selecting an operating mode.

According to an embodiment of the present disclosure, the functional module 8 is functionally alternative to the selector switch 7.

According to an embodiment of the present disclosure, the selector switch 7 is functionally alternative to the function module 8

According to another embodiment of the present disclosure, a backup with add-on module is automatically and fully implemented in the cloud.

FIG. 2 shows schematically how an operator BD plugs an add-on module ZM onto a field device F1 or connects it to F1′ according to one embodiment of the present disclosure.

According to another embodiment of the present disclosure, a backup with add-on module is automatically and fully implemented in the cloud.

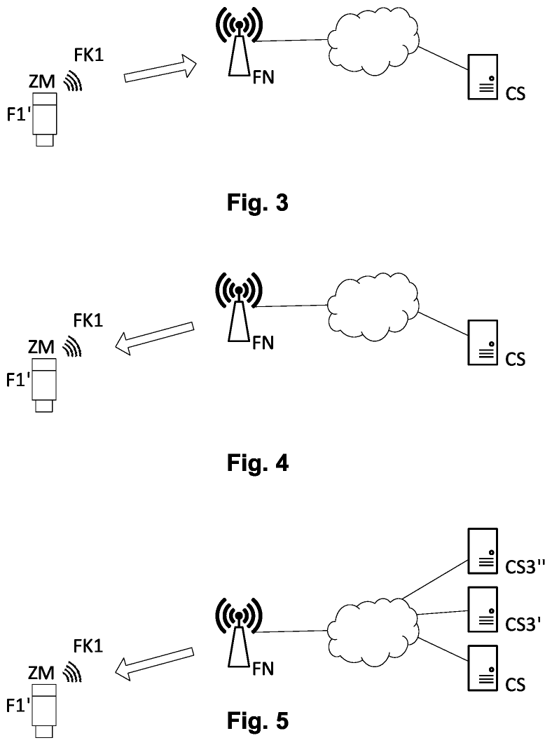

According to an embodiment of the present disclosure, FIG. 3 schematically shows a field device F1′ with an add-on module ZM, which, after being plugged in or connected, automatically transmits the backup data to the cloud-based system CS via a radio communication FK1 using a radio network FN.

According to another embodiment of the present disclosure, a restore with add-on module is implemented automatically and completely from the cloud.

According to an embodiment of the present disclosure, FIG. 4 schematically shows a field device F1′ with an add-on module ZM, which automatically receives the restored data from the cloud-based system CS via a radio network FN after being plugged in or connected via a radio communication FK1.

According to another embodiment of the present disclosure, a restore with add-on module is implemented automatically from the cloud in addition with at least one further cloud.

According to an embodiment of the present disclosure, FIG. 5 schematically shows a field device F1′ with an add-on module ZM, which automatically receives the restored data via a radio network FN from the cloud-based system CS after being plugged in or connected via a radio communication FK1. Add-on to example 42 or more 3rd party cloud based systems CS3′, CS3″ are connected, which provide additional restored data, such as software updates for the field devices F1′.

According to another embodiment of the present disclosure, a restore with add-on module via smartphone with Bluetooth as selection is implemented automatically from the cloud.

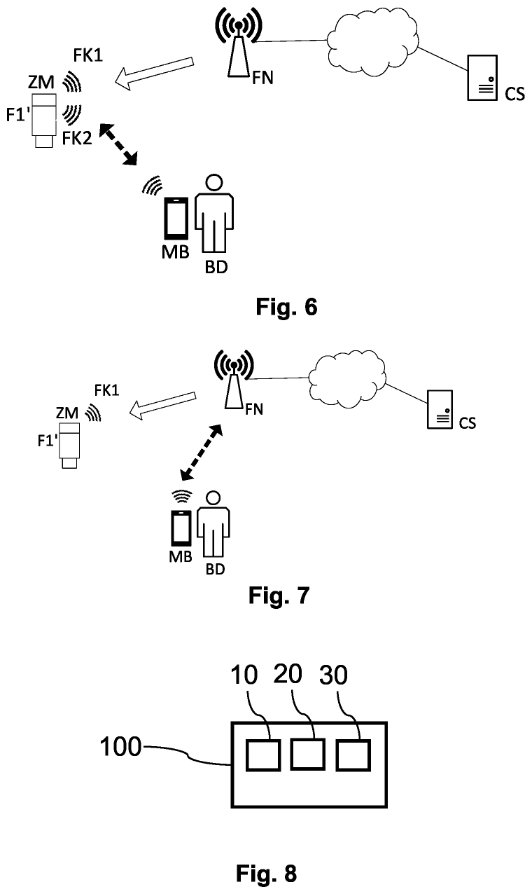

According to an embodiment of the present disclosure, FIG. 6 schematically shows a field device F1′ with an add-on module ZM which, after being plugged in or connected, automatically receives the restored data from the cloud-based system CS via a radio communication FK1 over a radio network FN. The operator explicitly selects and confirms the restore data via a second radio communication FK2, e.g. Bluetooth, which is connected to the mobile operating device MB of the operator BD.

According to another embodiment of the present disclosure, a restore with add-on module via smartphone mobile communication is implemented as a selection automatically from the cloud.

According to an embodiment of the present disclosure, FIG. 7 schematically shows a field device F1′ with an add-on module ZM, which automatically receives the restore data from the cloud-based system CS via a radio communication FK1 after being plugged in or connected via a radio network FN. The operator BD explicitly selects and confirms the restore data via the mobile radio communication, e.g. mobile radio, of the mobile operating device MB of the operator to the cloud-based system CS.

FIG. 8 shows an add-on module according to a further embodiment of the present disclosure.

The add-on module 100 is configured to provide data backup for a field device, the add-on module comprising a coupling device 10, a data interface device 20, and comprises a backup device 30.

### LIST OF REFERENCE SIGNS

F1 Field device(s)
F1′ Field device(s) with add-on module
ZM Add-on module
1 Interface to field device
2 Voltage supply from field device
3 Optional battery/accumulator
4 Optional signaling
5 Radio connection to cloud
6 Radio connection to optional control unit
7 Operating mode selector switch
8 Function block operating mode
BD Operator, user
FK1 . . . FKn Radio communication
FN Radio network
CS Cloud based system
CS3′, CS3″ 3rd party cloud based systems
MB Mobile operating device

It should be noted in addition that “comprising” and “having” do not exclude other elements or steps, and the indefinite articles “a” or “an” do not exclude a plurality.

Furthermore, it should be noted that features or steps that have been described with reference to one of the above embodiments may also be used in combination with other features or steps of other embodiments described above. Reference signs in the claims are not to be regarded as limitations.

1. An add-on module for data backup for a field device, the add-on module comprising:
a coupling device configured to couple the add-on module to the field device;
a data interface device configured to provide a first data communication link between the field device and the add-on module and to provide a second data communication link between the add-on module and a cloud-based system; and
a backup device configured to store backup data for data backup for the field device on the cloud-based system using the first data communication link and the second data communication link.

2. The add-on module according to claim 1, wherein the coupling device includes a connector which is configured to be detachably fixed to the field device by positive locking, by spring force, or by screwing.

3. The add-on module according to claim 1, further comprising a power supply device configured to provide a power supply to the add-on module via the field device and/or via an electrical energy storage integrated in the add-on module.

4. The add-on module according to claim 1, further comprising a display device configured to output a visual data display or a signaling to an operator.

5. The add-on module according to claim 1, wherein the data interface device is further configured to provide the first data communication link and/or the second data communication link by first, second, or third generation cellular standard, narrowband Internet of Things, low energy wide area network, or wireless local area network.

6. The add-on module according to claim 1, wherein the data interface device is further configured to provide a third data communication link between the add-on module and an operating device via short-range radio technology.

7. The add-on module according to claim 1, wherein the backup device is further configured to store, in a backup mode, the backup data for data backup for the field device as individual parameters, as parameter blocks for a linearization or for interference signal suppressions, as measured value memory, as event memory, as drag pointer, as configuration data, as field device information, as diagnostic data, or as certificates.

8. The add-on module according to claim 1, wherein the backup device is further configured to copy the backup data back to the field device in a restore mode as individual parameters, as parameter blocks for linearization or for interference signal suppressions, as measured value memories, as event memories, as drag pointers, as configuration data, as field device information, as diagnostic data, or as certificates.

9. The add-on module according to claim 1, further comprising an input device configured to switch the add-on module between restore mode and backup mode.

10. The add-on module according to claim 1, wherein the coupling device is further configured to identify the field device and to provide a unique sensor identifier, preferably a serial number, a device type, a manufacturer, or a marker tag, for the field device, wherein the add-on module is configured to provide the backup data with the unique sensor identifier.

11. The add-on module according to claim 1, further comprising circuitry configured to provide the backup data with a time stamp.

12. The add-on module according to claim 1, further comprising a data memory configured to store additional recovery data, and/or a cloud interface configured to provide a connection to cloud-based systems.

13. A field device comprising the add-on module according to claim 1.

14. A method of data backup for a field device, the method comprising:
coupling an add-on module with the field device;
providing a first data communication link between the field device and the add-on module,
providing a second data communication link between the add-on module and a cloud-based system; and
storing backup data for data protection for the field device on the cloud-based system using the first data communication link and the second data communication link.

15. A non-transitory computer readable medium having stored thereon a program that when executed by a computer causes the computer to implement the method according to claim 14.

16. The add-on module according to claim 3, wherein the power supply device is configured to provide the power supply to the add-on module via a wired field device with 4 . . . 20 mA HART standard.

17. The add-on module according to claim 12, wherein the data memory is configured to store software data for field devices or certificates as the additional recovery data.

18. The add-on module according to claim 12, wherein the cloud interface is configured to provide the connection to the cloud-based systems for authenticating the add-on module or for using the add-on module via a user interface or for providing two-factor authentication.

19. The add-on module according to claim 2, further comprising a power supply device configured to provide a power supply to the add-on module via the field device and/or via an electrical energy storage integrated in the add-on module.
